(19) United States
(12) Patent Application Publication
(10) Pub. No.: US 2013/0141902 A1
(43) Pub. Date: Jun. 6, 2013

(54) POLE SUPPORT SYSTEM

(71) Applicant: Omer AKDAG, Palm City, FL (US)

(72) Inventor: Omer AKDAG, Palm City, FL (US)

(73) Assignee: SOL INC., Palm City, FL (US)

(21) Appl. No.: 13/309,548

(22) Filed: Dec. 1, 2011

(51) Int. Cl. F21L 4/00; F16M 13/00

(52) U.S. Cl. 362/191; 248/530

(57) ABSTRACT

A light supporting system comprises a pole base and pole member. The pole member can be placed over the tubular member of the pole base. The adjustable mounting mechanism comprises a pivot bracket, an arcuate bracket, a pole mount, and a fastener. A photovoltaic array may be attached to the pivot bracket. The light supporting system and adjustable mounting mechanism can be used separately or in combination to form a system for a solar street lamp.

### FIELD

The field of the invention is pole systems for outdoor use, specifically pole systems and mechanisms for use with pole-mounted items.

### BACKGROUND

Pole systems have been used to support lights, antennas, cameras, signs, and other items. Examples of pole construction include, but are not limited to, solid, tubular, or framework construction.

It is known that poles in general can be erected by making a hole in the ground and inserting the pole. In the past, pole systems have been erected by attaching a pole base to a concrete foundation. This is a time-consuming method of pole installation.

Pole systems may also be used as supports in solar lighting. In solar lighting arrangements, solar panels are employed for providing power to lighting systems such as road lights. It is important that the solar panels face the correct direction and be at the correct angle. Solar panels should face true south for optimal performance. When natural or man-made objects would obstruct the sunlight if the solar panels faced true south, the solar panels should be rotated to the southeast or southwest for optimal sunlight collection. Orienting the solar panels after the pole is installed is a challenging operation. It occurs at ten to thirty feet above the ground and requires rotation of the solar panels to the correct orientation in addition to drilling matching holes to the pole to attach the solar panel to the support structure. There may also be a large quantity of solar panels that need to be installed in the case of a parking lot, street, or sidewalk. Making the installation of poles and solar panels faster saves time and money.

### BRIEF SUMMARY

A light supporting system is disclosed herein. The light supporting system is a configuration for holding a pole that is erected on a surface and corresponds to a base.

An adjustable mounting mechanism is also disclosed herein. The adjustable mounting mechanism provides the ability to change the direction that a pole top item will face and the tilt angle of a pole top item even after the pole has been installed.

The light supporting system and the adjustable mounting mechanism may be used in combination or separately. A light supporting system may be used with any pole top and an adjustable mounting mechanism may be used with any method of supporting a light pole. If used together, the combination will be referred to herein as a system for a solar street lamp. A system for a solar street lamp is disclosed herein.

Disclosed herein is an example of a light supporting system comprising: a base; a tubular member having a first end and a second end and with the second end being adapted for coupling to the base, wherein the tubular member having an exterior structure surface arranged in a repeating pattern of grooves; a pole member has an interior structure arranged in a repeating pattern of protrusions corresponding to and adapted for corresponding to the grooves of the exterior structure of the tubular member; the exterior structure and interior structure configured so that the pole member and the tubular member have a plurality of engaged positions. The exterior structure comprises at least one groove. The grooves include grooves of a first width and grooves of a second width. The grooves are spaced apart circumferentially at a predetermined or random angle from one another. The grooves of a first width are semi-circular. In another example, the grooves have a first end and a second end. The grooves on the base of a first width are tapered from the first end to the second end. The tubular member can have a hollow center or solid center in the interior of the tubular member. The interior of the pole member comprises a plurality of protrusions. The plurality of protrusions has a first shape and a second shape. The first shape and second shape are formed to correspond to grooves formed on the tubular member. The repeating pattern of grooves comprises at least one set of grooves. There is a first set forming rectangular grooves and a second set forming semi-circular grooves. The first set and second set of grooves are arranged in an alternating pattern of rectangle grooves and semi-circular grooves. The pole member in a first position is set at a predetermined angle of rotation, with respect to the tubular member, from a second position.

Disclosed herein is an example of an adjustable mounting mechanism for a street lamp comprising: a pole component; a pole mount coupled to the pole component; an arcuate bracket seated on the pole mount; a pivot bracket conically engaged with the arcuate bracket; and a fastener that projects through the pivot bracket, the arcuate bracket, and the pole mount and engages with the pole component. The fastener is a bolt. The fastener projects through a washer. The pivot bracket is releasably coupled to the pole component. The fastener threadingly engages a hole in the pole component. The pivot bracket is slidingly engaged with the arcuate bracket. The pivot bracket is rotatably engaged with the arcuate bracket. The pole mount is attached to the pole component with a plurality of bolts. The plurality of bolts projects through the pole mount and threadingly engages semi-circular grooves of the pole component. A photovoltaic array is attached to the pivot bracket. The pole top item attachment surface of the pivot bracket is attached to the pivot bracket attachment surface of the photovoltaic array. The pole top item attachment surface of the pivot bracket is attached to the pivot bracket attachment surface of the photovoltaic array with bolts. The adjustable mounting mechanism also includes tilt angle markings and a tilt angle indicator.

Disclosed herein is an example of a system for a solar street lamp comprising: a base; a tubular member having a first end and second end with the second end adapted for coupling to the base, wherein the tubular member has an exterior surface arranged in a repeating pattern of grooves; a pole member having a first end and a second end; wherein the first end of the pole member has an interior structure arranged in a pattern of protrusions corresponding to and adapted for matingly engaging with the grooves of the exterior structure of the tubular member; the exterior structure and interior structure configured so that the first end of the pole member and the tubular member have a plurality of engaged positions; a pole member; a pole mount coupled to the pole member; an arcuate bracket seated on the pole mount; a pivot bracket conically engaged with the arcuate bracket; and a fastener that projects through the pivot bracket, the arcuate bracket, and the pole mount and engages with the pole member. At least one photovoltaic array is attached to the pivot bracket. The pole top item attachment surface of the pivot bracket is attached to the pivot bracket attachment surface of the photovoltaic array. The adjustable mounting mechanism also comprises tilt angle markings and a tilt angle indicator. A light fixture is attached between the first end of the pole member and the second end of the pole member. A battery box is attached between the first end of the pole member and the second end of the pole member. The battery box may contain a battery and a controller. The system for a solar street lamp further comprises a light fixture attached between the first end of the pole member and the second end of the pole member. The system for a solar street lamp further comprises a battery box attached between the first end of the pole member and the second end of the pole member. The battery box has a battery and a controller disposed therein.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts a system for a solar street lamp.

FIG. 2 depicts a pole base.

FIG. 3A depicts a pole and pole base.

FIG. 3B depicts a cross-sectional view of a hollow pole placed over the tubular member.

FIG. 3C depicts a system for a solar street lamp under the force of wind.

FIG. 3D depicts a light supporting system under the force of wind.

FIG. 3E depicts a cross-sectional view a hollow pole placed over the tubular member under the force of wind.

FIG. 4A depicts an exploded perspective view of an adjustable mounting mechanism for a pole.

FIG. 4B depicts an exploded side view of an adjustable mounting mechanism for a pole.

FIG. 4C depicts an assembled side view of an adjustable mounting mechanism for a pole.

FIG. 5 depicts an assembled perspective view of an adjustable mounting mechanism for a pole.

FIG. 6 depicts a battery box present on a solar lighting assembly.

### DETAILED DESCRIPTION

The disclosure relates to pole top item supporting systems, light supporting systems, photovoltaic array (i.e., solar panel) mounting systems, and a system for a solar street lamp. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein. Elements labeled by reference numerals are meant to be examples and are not meant to limit the claims to a particular embodiment.

The term “photovoltaic array”, when used in this specification and claims, refers to a structure capable of collecting solar energy and turning it into electricity, for example, a linked collection of photovoltaic cells. The term “solar panel”, may also be used herein in this manner.

The term “tilt angle”, when used in this specification and claims, refers to the angle formed between the plane of a pole top item and the horizontal plane.

The term “correspond”, when used in this specification and claims, refers to being compatible but not necessarily touching.

A light supporting system is disclosed with a base and a tubular member projecting upward from the base and a pole with an interior that corresponds with the exterior of the tubular member to provide a slip fit. The base is attached to a surface. The light supporting system provides a solid interaction at the base of the pole to hold a light pole in a given location. An exemplary light supporting system is presented herein.

An adjustable mounting mechanism is disclosed. The adjustable mounting mechanism may be located at the top of a pole and may be for a solar street lamp. The adjustable mounting mechanism contains a fastener, pivot bracket, arcuate bracket, and a pole mount. A pivot bracket may be any structure that is capable of sliding adjustment relative to the arcuate bracket, thus adjusting the tilt angle of any pole top item attached to the pivot bracket. An arcuate bracket may be any structure that supports the pivot bracket while allowing the pivot bracket to slidingly adjust relative to the arcuate bracket. A pole mount may be any structure that supports the arcuate bracket while allowing rotation of the arcuate bracket within the pole mount. The adjustable mounting mechanism allows a pole top item to be rotated and the tilt angle of the pole top item adjusted. The pivot bracket, arcuate bracket, and pole mount may be releasably coupled by a fastener. In an example, a photovoltaic array is attached to the adjustable mounting mechanism. An exemplary adjustable mounting mechanism is presented herein.

A system for a solar street lamp may use some or all of the components of the light supporting system and adjustable mounting mechanism. An exemplary system for a solar street lamp is presented herein.

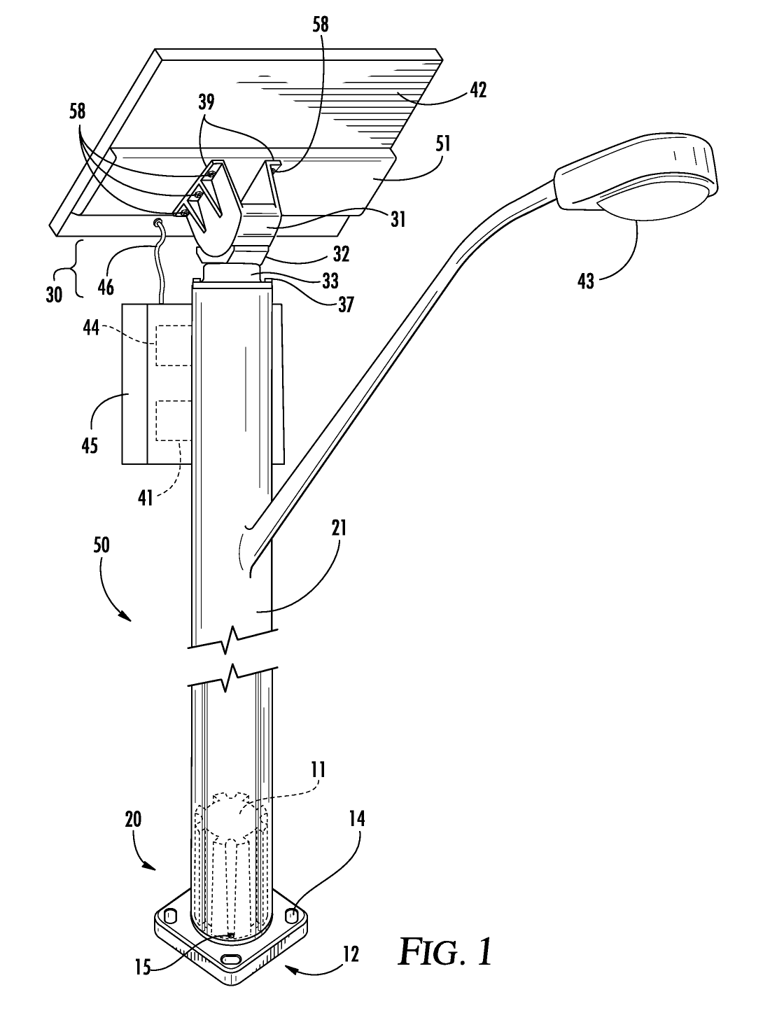

FIG. 1 depicts an example of a system for a solar street lamp 50 with a base 12, tubular member 11, pole member 21, and adjustable mounting mechanism 30 used in combination. The base 12 and tubular member 11 along with the pole member 21 form a light supporting system 20. The pole member 21 corresponds to the tubular member 11 to provide support to the pole member 21 in a vertical position and the ability to transfer forces from the pole member 21 to the tubular member 11. The exterior of the pole member 21 may be grooved, fluted, smooth, or any suitable surface. An adjustable mounting mechanism 30 is present at the top of pole member 21. The adjustable mounting mechanism 30 uses a pivot bracket, such as a universal pivot bracket 31, capable of slidably adjusting relative to the pole member 21, to change the tilt angle of a photovoltaic array 42. A fastener, when tightened, holds the universal pivot bracket 31 in a desired orientation. The universal pivot bracket 31 is conically engaged with an arcuate bracket, such as a universal A-Z bracket 32. The universal A-Z bracket 32 is seated on a pole mount, such as a universal TPM 33. The universal TPM 33 is attached to the pole member 21 by pole top bolts 37. The pole top bolts 37 threadingly engage semi-circular grooves of the pole member 21. The fastener projects through a washer and through the universal pivot bracket 31. The fastener also projects through the universal A-Z bracket 32 and the universal TPM 33 to engage pole member 21. The universal A-Z bracket 32 may be rotated when the fastener is not tightened. Rotation of the universal A-Z bracket 32 allows adjustment of the direction in which the photovoltaic 42 array faces. A pivot bracket attachment surface 51 is present on the back of the photovoltaic array 42. In an example, the pole top item attachment bolts 58 project through the pole top item attachment surface 39 and into the pivot bracket attachment surface 51 to attach the photovoltaic array 42 to the adjustable mounting mechanism 30. In another example, the head of the pole top attachment bolts 58 slide into a groove in the pivot bracket attachment surface 51 and projects through the pole top item attachment surface 39. Screws, bolts, or other fasteners may be used to attach the pole top item attachment surface 39 to the pivot bracket attachment surface 51. A photovoltaic array 42 is attached to the pivot bracket attachment surface 51 which is then attached to the universal pivot bracket 31. As an example, a light fixture 43 is attached to the pole member 21 between the light supporting system 20 and the adjustable mounting mechanism 30. A controller 44 and battery 41 are present within a battery box 45 that is attached to the pole member 21. The photovoltaic array 42 and battery box 45 as well as the light fixture 43, are interconnected with wires 46.

Solar lighting utilizes a photovoltaic array 42 to convert the energy of the sun into electricity. This electricity powers the light fixture 43. A photovoltaic array 42 generates electricity as light energy (photons) from the sun rays contacts the photovoltaic array 42. The energy is stored in a battery or batteries 41. The battery 41 may be a gel-type battery. A smaller photovoltaic array 42 may be required in areas with more frequent or intense sun. The energy from the battery 41 operates the light fixture 43. The light fixture 43 may comprise a light emitting diode (LED).

It is preferable that the photovoltaic array 42 faces the correct direction and at the correct angle in order to capture the maximum amount of energy. Preferably, the photovoltaic array 42 is installed so that it faces the equator. Therefore in the Northern Hemisphere, the photovoltaic array 42 is installed to face generally south. In the Southern Hemisphere, the photovoltaic array 42 is installed to face generally north.

The desired tilt angle of the photovoltaic array 42 depends upon the latitude of the geographic location of the light installation. At the equator, the solar panel should be perpendicular to the pole. In order to determine the proper tilt angle for the solar panel, various publications or websites may be consulted. In an example, the following website may be consulted to determine the proper tilt angle of the solar panel: http://mapserve3.nrel.gov/PVWatts_Viewer/index.html. The PVWatts™ calculator, available on the website of the National Renewable Energy Laboratory, determines the energy production and cost savings of grid-connected photovoltaic energy systems. Additional information may be found at http://www.nrel.gov/rredc/pvwatts. The calculator uses default values for size of the array, electric cost, array type, tilt angle, and azimuth angle but users may substitute their own system parameters. The default tilt angle used by the calculator is equal to the location's latitude. Utilizing the tilt angle equal to the location's latitude maximizes for annual energy production. If the tilt angle is increased, energy production in the winter is maximized whereas decreasing the tilt angle maximizes energy production in the summer. The tilt angle can be fixed at the time of installation or alternatively, modified based upon the season. Ideally, the sun's rays should be perpendicular to the photovoltaic array 42.

A system for a solar street lamp 50 may be used for solar street and area lighting. Components of the system for a solar street lamp 50 may be used for any other purpose for which they are suitable, such as to support antennas, cameras, and signs. The system for a solar street lamp may be made of aluminum or other suitable material. Examples of other suitable materials include plastic, steel, composite, bronze, or concrete. The needs of the particular project may influence the material used. The system for a solar street lamp 50 may be powder coated. Poles may be solid, hollow, or partially hollow. As stated above, hollow poles of the same material as a solid pole weigh less but may not be as strong. Hollow poles may allow access to the interior of the pole. The needs of a particular project may influence the type of pole selected.

Benefits of a pole with an adjustable top are ease of installation and reduced installation time. The installer may be in the air at the top of the system for a solar street lamp 50 while installing the photovoltaic array 42 in the desired position so that the photovoltaic array 42 is attached facing the correct direction and at the correct angle.

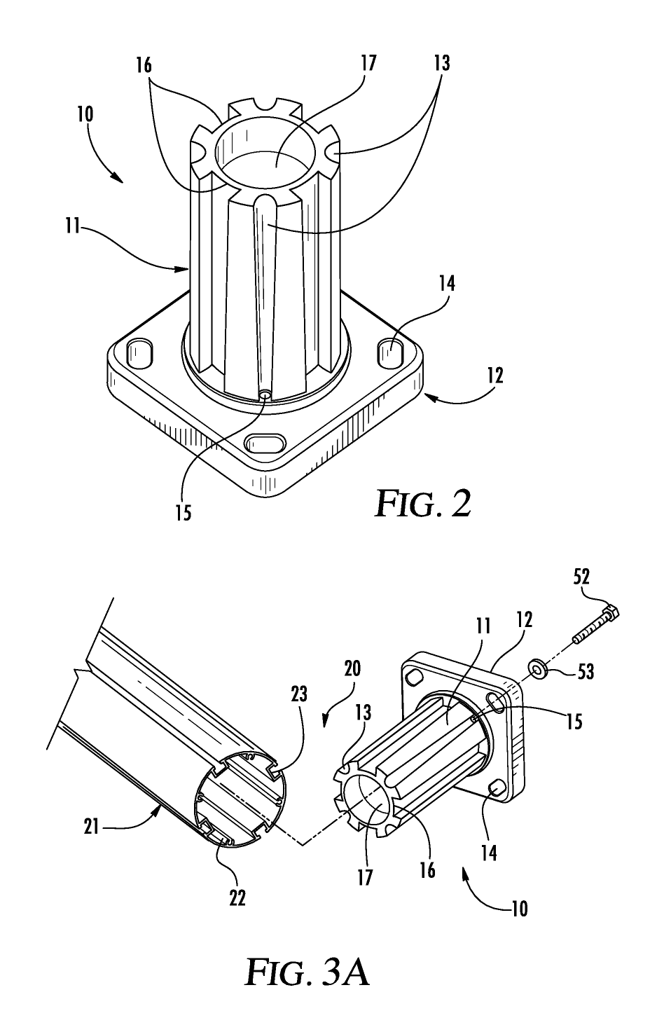

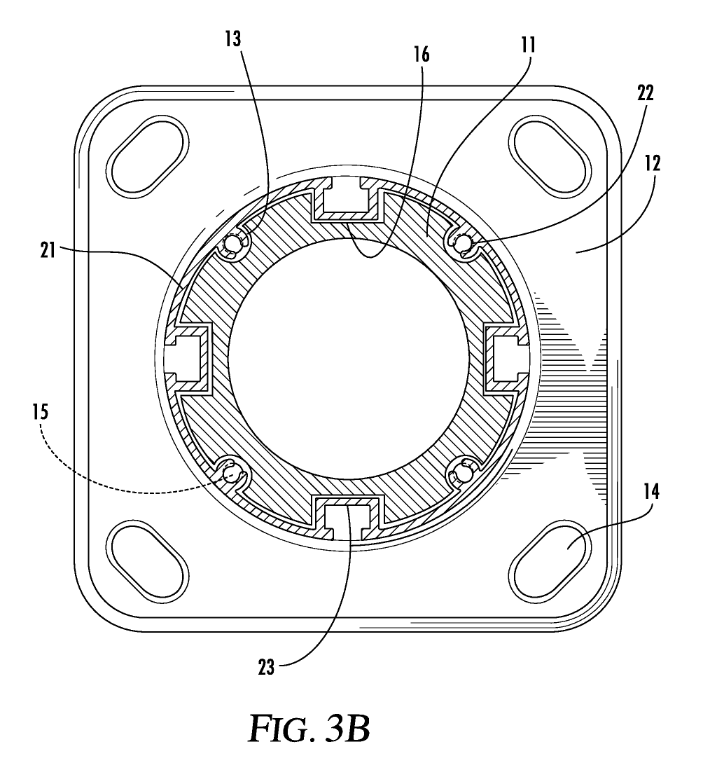

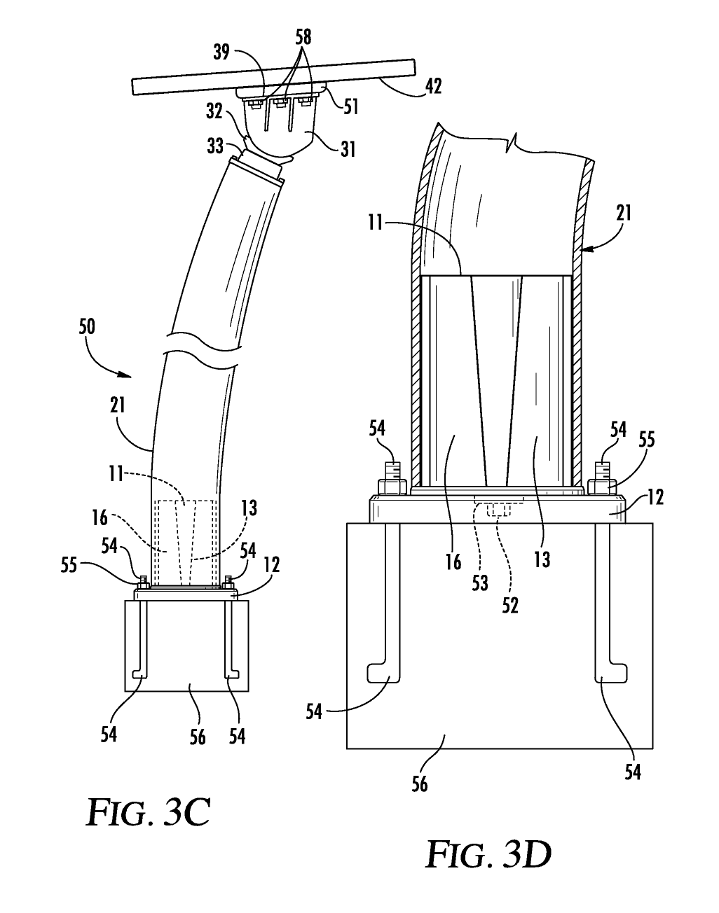

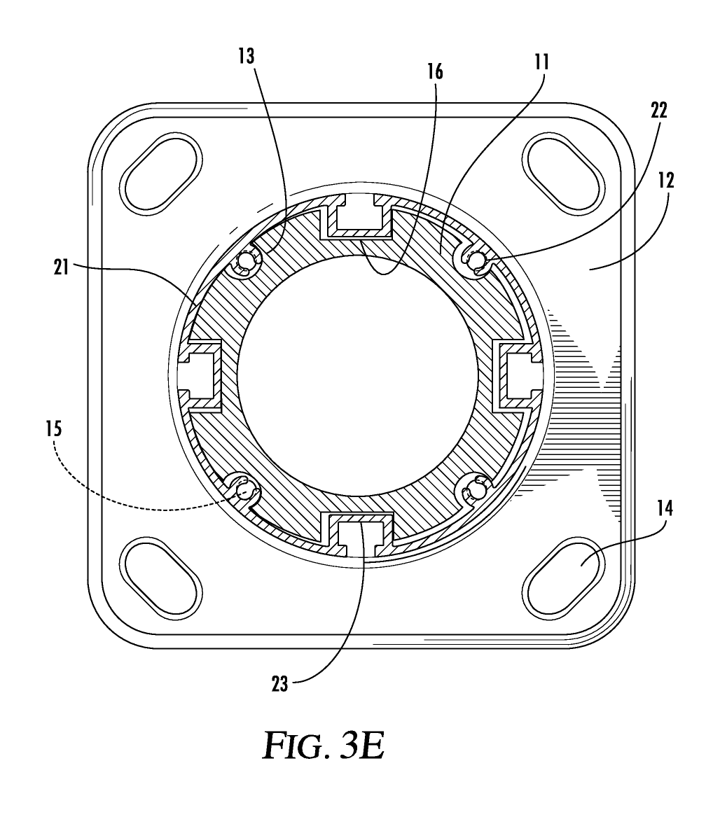

An example of a light supporting system is presented in FIGS. 2 and 3A. As shown in FIG. 2, the light support system includes a pole base 10 comprised of a base 12 and a tubular member 11. The pole base 10 includes a base 12 (lower portion of pole base 10) for engaging a surface such as the ground. The pole base 10 can be attached to the ground using any type of fastening devices or anchors. The base 12 may include slots 14 to allow fastening devices to pass through. The slots 14 may be recessed to allow for the fastening device or anchor to be covered following installation.

As shown in an example of the light supporting system in FIG. 2 the tubular member 11 has a first and second end with the second end adapted for coupling to the base 12. The exterior circumference of the tubular member 11 is arranged in a repeating pattern of grooves. The pattern of grooves may be of any shape, and any repeating pattern of those shapes may be used. For example, FIG. 2 shows a repeating pattern of grooves that comprises a first set of rectangular grooves 16 and a second set of semi-circular grooves 13. The first set of rectangular grooves 16 and second set of semi-circular grooves 13 may alternate as shown in FIG. 2. Any number of grooves may be present. FIG. 2 depicts eight grooves. In another example, the exterior structure may contain at least four grooves. The grooves may be of a first width and second width. As an example, FIG. 2 depicts the rectangular grooves 16 of a greater width than the semi-circular grooves 13.

As shown in FIG. 2, the grooves of the tubular member 11 may be substantially evenly spaced apart circumferentially at a predetermined angle. In another example, the grooves of the tubular member 11 are not substantially evenly spaced apart. FIG. 2 depicts a spacing of approximately forty-five degrees from the center of a rectangular groove 16 to the center of a semi-circular groove 13. FIG. 2 depicts that the spacing from the center of each repeat of a rectangular groove 16 and semi-circular groove 13 is ninety degrees. Any type of spacing that allows the grooves of the tubular member 11 to correspond to the protrusions of the pole member 21 may be used. In an example, the groove of a first width is a semi-circular groove 13. The semi-circular groove 13 has a first end and a second end. In an example, the semi-circular groove 13 is tapered from the first end to the second end. In an example, the width of the semi-circular groove 13 narrows as it approaches the base 12. A benefit of the narrowing groove is that it allows the cast tubular member 11, to come out of the cast easier. A benefit of the light supporting system that contains a repeating pattern of grooves with a narrowing semi-circular groove 13 and a pattern of protrusions 22 and 23 that correspond to the grooves is that the light supporting system is variably adjustable and the corresponding features provide a secure interaction and the ability to transfer forces between the pole base 10 and pole member 21.

In an example, the width of the grooves is less than the spacing between the grooves. The tubular member 11 may have a hollow center 17. The base 12 may have four attachment holes 15 through the base 12. Fastening devices, such as screws with washers may be projected through the base 12 and into the semi-circular grooves 13. Steel, thread-cutting, screws may be used to project through the base 12 and into the semi-circular groove 13 with silicone washers present between the steel, thread-cutting screws. Any other suitable fastening device or screws may be used.

As shown in FIG. 3A, the pole base 10 includes the tubular member 11 (upper portion of pole base 10) adapted to correspond to the pole member 21. The interior structure of the pole member 21 is such that it corresponds to the exterior structure of the tubular member 11. FIG. 3A shows an example of a light supporting system 20 where the tubular member 11 corresponds to a pole member 21. This occurs when the pole member 21 is placed on the pole base 10.

The pole base 10 can be used to support a pole member 21 attached to overhead power lines, cables, and related equipment such as transformers and lights. As discussed herein, the pole base 10 supporting a light pole is provided as an example but the pole base 10 could be used to support other items as well.

As shown in FIG. 3A, the interior of the pole member 21 is arranged in a pattern of protrusions that correspond to the grooves at the exterior of the tubular member 11. In an example, the protrusions have a first shape and a second shape. The interior of the pole member 21 may have rectangular protrusions 23 and crescent-shaped protrusions 22. The first and second shapes are formed to correspond to the adjacent grooves formed on the tubular member 11. Other protrusion shapes may be used as long as the shapes correspond to the grooves of the tubular member 11. In an example, the exterior structure of the tubular member 11 and interior structure of the pole member 21 may have a plurality of engaged positions. In an example, the pole member 21 in a first position is at a predetermined angle of rotation with respect to the tubular member 11 from a second position. The pole member 21 may contain grooves on the exterior surface. As an example, the grooves on the exterior surface of pole member 21 may correlate with the rectangular protrusions 23 on the interior surface of the pole member 21. The pole member 21 may have countersunk portions in the bottom of the pole member 21 to accommodate the fastening devices projecting through four attachment holes 15 in the base 12. In an example, the fastening devices are screw 52 that project through washer 53 and attachment hole 15. Various sizes of protrusions and grooves may be used as long as they are capable of corresponding in order to transfer force.

The pole member 21 may be hollow, partially hollow, or solid with a bottom opening. Hollow poles provide a lighter-in-weight pole than a solid pole of the same material and provide access to the pole interior. The needs of the particular project may influence the type of pole selected. The pole member 21, base 12, and tubular member 11 may be produced by extrusion, machining, forging, casting, or other suitable method. As an example, the pole member 21 shown in FIG. 3A is produced by extrusion. The exterior of the pole member 21 may be grooved, fluted, smooth, or any suitable surface. In an example, the grooves may correspond with the rectangular protrusions 23. As shown in FIG. 2 and FIG. 3A, the tubular member 11 may have a hollow center 17. The pole member 21 may contain a center portion that can be received in the hollow center 17 of the tubular member 11. A benefit of the pole containing a center formation is that there are additional corresponding surfaces between the pole member 21 and tubular member 11, providing a more secure mounting system and mechanism of transferring force. The tubular member 11 may be hollow, solid, or partially hollow. As an example, the tubular member 11, shown in FIGS. 2 and 3A, has a hollow center 17. As an example, the base 12 and tubular member 11 are cast and may be formed from one piece or multiple pieces.

The pole base 10 is attached to a surface and then the pole member 21 is placed over the tubular member 11 of the pole base 10. A benefit of using a pole base 10 and pole member 21 is that a number of the pole bases 10 may be installed and the pole members 21 placed over the tubular members 11 at a later point in time. The corresponding surfaces of the tubular member 11 and pole member 21 provide a strong light supporting system 20 capable of transferring force. The top of pole member 21 may use any type of attachment to the item being supported.

FIG. 3B shows a cross-sectional view of an example of the pole member 21 placed over the tubular member 11. Rectangular protrusions 23 and crescent-shaped protrusions 22 are present on the interior of the pole member 21. Other protrusion shapes may be used as long they are capable of corresponding to the grooves of the tubular member 11. The rectangular protrusions 23 correspond to the rectangular grooves 16 of the tubular member 11. The crescent-shaped protrusions 22 correspond to the semi-circular grooves 13 of the tubular member 11. The corresponding grooves and protrusions can have space (or clearance) between the grooves and protrusions until a force, such as wind, causes the interior of the pole member 21 to contact the exterior of the tubular member 11. Fastening devices may project through four attachment holes 15 in the base 12 at the location of the semi-circular grooves 13. Anchors may project through slots 14.

FIG. 3C depicts an example of a system for a solar street lamp 50 under the force of wind. The example of a system for a solar street lamp 50 has a base 12, tubular member 11, pole member 21, and an adjustable mounting mechanism 30. The ground anchor 54 may project through the base 12. The ground anchor 54 is held in a concrete base 56. The ground anchor fastener 55 threadingly may engage the ground anchor 54 to hold base 12 in a desired position. FIG. 3C shows a pattern of semi-circular grooves 13 and rectangular grooves 16 on the tubular member 11. The pole member 21 corresponds to the tubular member 11 to allow for the transfer of forces, such as wind load, from the pole member 21 to the tubular member 11 and eventually to the ground anchors 54 held in the concrete base 56, therefore providing support to the pole member 21 in a vertical position.

FIG. 3D depicts an example of a base 12, tubular member 11, and pole member 21 under the force of wind. FIG. 3D shows a repeating pattern of semi-circular grooves 13 and rectangular grooves 16 on the tubular member 11. The ground anchor 54 may project through the base 12. The ground anchor 54 is held in a concrete base 56. The ground anchor fastener 55 may threadingly engage the ground anchor 54 to hold base 12 in a desired position. The pole member 21 may accommodate the fastening devices projecting through the base 12. In an example, the fastening devices are screws 52 that project through washers 53. A benefit of a repeating pattern of grooves spaced apart on tubular member 11 corresponding with the protrusions on the pole member 21 is that it allows for the transfer of forces, such as wind load, from the pole member 21 to the tubular member 11 and eventually to the ground anchors 54. Various sizes of protrusions and grooves may be used as long as they are capable of corresponding in order to transfer force.

FIG. 3E depicts a cross-sectional view of an example of a pole member 21 placed over the tubular member 11 experiencing the force of wind. Rectangular protrusions 23 and crescent-shaped protrusions 22 are present on the interior of the pole member 21. Other protrusion shapes may be used as long they are capable of corresponding to the grooves of the tubular member 11. The rectangular protrusions 23 correspond to the rectangular grooves 16 of the tubular member 11. The crescent-shaped protrusions 22 correspond to the semi-circular grooves 13 of the tubular member 11. When experiencing forces, such as wind, the corresponding grooves and protrusions touch on one side of the pole member 21 and have space (or clearance) between the grooves and protrusions on the other side of the pole member 21 due to the force causing the interior of the pole member 21 to contact the exterior of the tubular member 11. Deforming of the pole member 21 due to wind load causes the crescent-shaped protrusions 22 on pole member 21 to contact the semi-circular groove 13 on the exterior surface of tubular member 11 and the rectangular protrusion 23 on pole member 21 to contact the rectangular groove 16 on the exterior surface of tubular member 11. Fastening devices may project through four attachment holes 15 in the base 12 at the location of the semi-circular grooves 13. Anchors may project through slots 14.

In other examples of the light supporting system, the exterior structure comprises at least one groove. The groove or grooves may vary in width. If more than one groove is present, there may be grooves of a first width and grooves of a second width. The grooves may be spaced apart circumferentially by various distances and at varying angles from one another. The grooves may be of varying shapes. The grooves may or may not taper from a first end to a second end. The center of the tubular member 11 may be solid or hollow. The pole member 21 is placed over the tubular member 11. Preferably, the surfaces of pole member 21 and tubular member 11 do not substantially contact each other than at the bottom surface of the pole member 21 until a force, such as wind, causes a deformation of the pole member 21. The deformation of the pole member 21 causes the protrusions on the interior of the pole member 21 to come into contact with the exterior of the tubular member 11.

FIG. 3A depicts screw 52 that projects through the center of a washer 53. The portion of the screw 52 that projects through the center of washer 53 projects through attachment hole 15. The washer 53 may be manufactured of rubber, silicone, or any material that is capable of deformation. In an example, the washer 53 is capable of deforming when the pole member 21 sustains wind load. Wind or other load on the pole member 21 drives the inner surface of the pole member 21 to come into contact with the outside surface of the tubular member 11 and transfer the force to the tubular member 11 and eventually to the ground anchor 54 through the interface. In an example, the screw 52 will carry little load. The screw 52 may be self-threading (self-tapping).

The crescent-shaped protrusions 22 of pole member 21 interface with the screw 52. In an example, when pole member 21 is manufactured by extrusion, crescent-shaped protrusions 22 are included instead of a closed-circle protrusion because a crescent-shaped protrusion is easier to create by extrusion than a closed-circle protrusion.

FIG. 1 depicts an example of an adjustable mounting mechanism 30 used in an exemplary system for a solar street lamp 50 with a base 12, tubular member 11, and pole member 21. Also depicted in FIG. 1 are a photovoltaic array 42, a light fixture 43, battery box 45, controller 44, battery 41 and wires 46. The adjustable mounting mechanism 30 may be used with any pole and pole base.

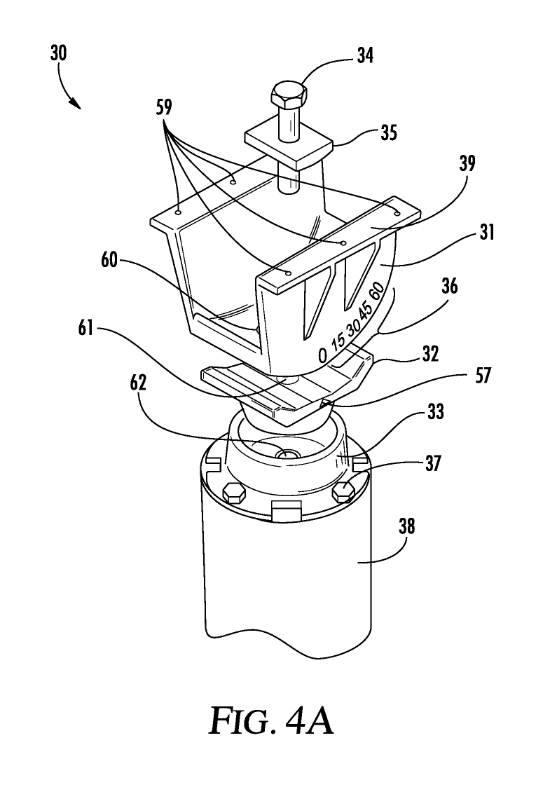

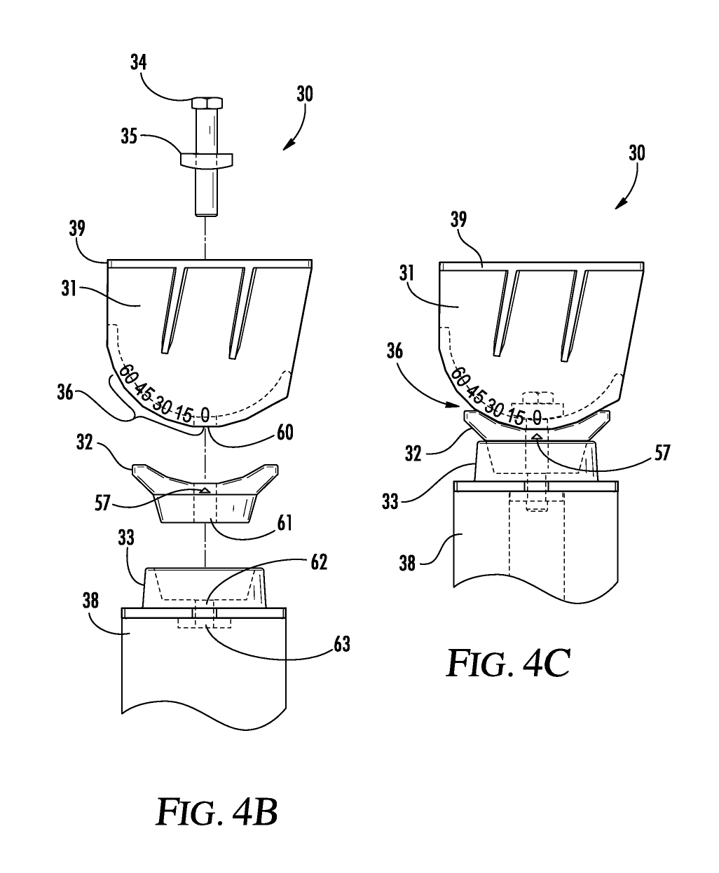

FIGS. 4A, 4B, and 4C show details of the adjustable mounting mechanism 30. FIG. 4A shows an exploded perspective view of an example of the adjustable mounting mechanism 30 comprising a pivot bracket, such as a universal pivot bracket 31, conically engaged with an arcuate bracket, such as a universal A-Z bracket 32, seated on a pole mount, such as a universal TPM 33. The pole mount is releasably attached to the top of pole component 38 by pole top bolts 37. The pole top bolts 37 project through the universal TPM 33 and threadingly engage semi-circular grooves of the pole component 38. The universal TPM 33 may be constructed to correspond with the rectangular protrusions 23 of the pole component 38. The universal pivot bracket 31, universal A-Z bracket 32, and universal TPM 33 have a hole or bore through which the fastener 34 can project. Fastener 34 projects through a washer hole in the washer 35 and through an elongated pivot bracket hole 60 in the universal pivot bracket 31. The fastener 34 also projects through a A-Z bracket hole 61 in the universal A-Z bracket 32 and a TPM hole 62 in the universal TPM 33 to engage pole component 38. The fastener 34 may be a bolt or other method of fastening. The fastener 34 may project through and releasably couple the universal pivot bracket 31, universal A-Z bracket 32, and the universal TPM 33 to the pole component 38. The fastener 34, when tightened, holds the universal pivot bracket 31 in a desired orientation. The fastener 34 may be threadingly engaged with pole component 38.

When the fastener 34 is not tightened, the universal A-Z bracket 32 may be rotated to allow adjustment of the direction in which the photovoltaic array 42 faces. The tilt angle of the photovoltaic array 42 may be changed by sliding the universal pivot bracket 31 in relation to the universal A-Z bracket 32 so that a number present in the tilt angle markings 36 is lined up with the tilt angle indicator 57. The tilt angle markings 36 are located on the universal pivot bracket 31. The tilt angle indicator 57 is located on the universal A-Z bracket 32. The tilt angle indicator 57 points to the tilt angle marking 36 that corresponds to the tilt angle of the pole top item attachment surface 39 and therefore the tilt angle of a pole top item, such as a photovoltaic array 42 (FIG. 1). Referring to FIG. 4A, the tilt angle markings indicate the degrees of the angle of the pole top item attachment surface 39 from horizontal. The fastener 34 is tightened to retain the selected tilt angle of the universal pivot bracket 31.

The exemplary adjustable mounting mechanism 30 allows rotatable adjustment relative to the pole component 38 in order to change the facing direction of any pole top item. The universal TPM 33 may be integral to or coupled to the pole component 38. For example, the universal TPM 33 may be coupled to the pole component 38 by bolts or welding. The universal TPM 33 may be constructed to correspond with the rectangular protrusions 23 of the pole component 38. The exterior of the pole component 38 may be grooved, fluted, smooth, or any suitable surface. The fastener 34 may be an elongated protrusion that may be all or partially threaded.

The pole top item attachment surfaces 39 are used for attaching a pole top item. In an example, the pole top item attachment surfaces 39 are used to adhere the universal pivot bracket 31 to the pivot bracket attachment surface 51 of the photovoltaic array 42. The structure or structures used for attaching the photovoltaic panel, such as the pole top item attachment surfaces 39, may be any structure suitable to attach a photovoltaic panel to a pole.

FIG. 4B shows an exploded side view of an example of the adjustable mounting mechanism 30 comprising a pivot bracket, such as a universal pivot bracket 31, conically engaged with an arcuate bracket, such as a universal A-Z bracket 32, seated on a pole mount, such as a universal TPM 33. The pole mount is releasably attached to the top of pole component 38. The universal pivot bracket 31, universal A-Z bracket 32, and universal TPM 33 have a hole or bore through which the fastener 34 can project. Fastener 34 projects through a washer hole in the washer 35 and through an elongated pivot bracket hole 60 in the universal pivot bracket 31. The fastener 34 also projects through a A-Z bracket hole 61 in the universal A-Z bracket 32 and a TPM hole 62 in the universal TPM 33 to threadingly engage a central pole component hole 63 in pole component 38. The fastener 34 may be a bolt or other method of fastening. The fastener 34 may project through and releasably couple the universal pivot bracket 31, universal A-Z bracket 32, and the universal TPM 33 to the pole component 38. The fastener 34, when tightened, holds the universal pivot bracket 31 in a desired orientation. The fastener 34 may be threadingly engaged with pole component 38.

Pole component 38 may have the same interior structure as pole member 21 or pole component 38 may have a different interior structure than pole member 21. In an example, pole component 38 may be solid. In other examples, pole component 38 may be hollow or partially hollow. Upon rotating the universal pivot bracket 31 and universal A-Z bracket 32 to the desired direction and tilt angle, the universal pivot bracket 31 and universal A-Z bracket 32 may be fastened. The photovoltaic array 42 may be attached to the universal pivot bracket 31 by utilizing bolts and nuts to attach the pivot bracket attachment surface 51 to the pole top item attachment surface 39. The structure or structures used for attaching the photovoltaic array 42 to the universal pivot bracket 31 may be any structure suitable to attach the photovoltaic array 42 to the universal pivot bracket 31.

After a pole component 38 is installed at the desired location, an installer will attach the universal TPM 33 to the pole component 38 using a fastener. Alternatively, the universal pivot bracket 31 and universal A-Z bracket 32 may already be attached. The fastener may threadingly engage with a central pole component hole in pole component 38. Rotation of the universal A-Z bracket 32 changes the direction in which the pole top item faces while adjusting the universal bracket 31 changes the tilt angle of the pole top item. The tilt angle markings 36 indicate the tilt angle of the pole top item attachment surface 39 and thus indicate the angle of the photovoltaic array 42.

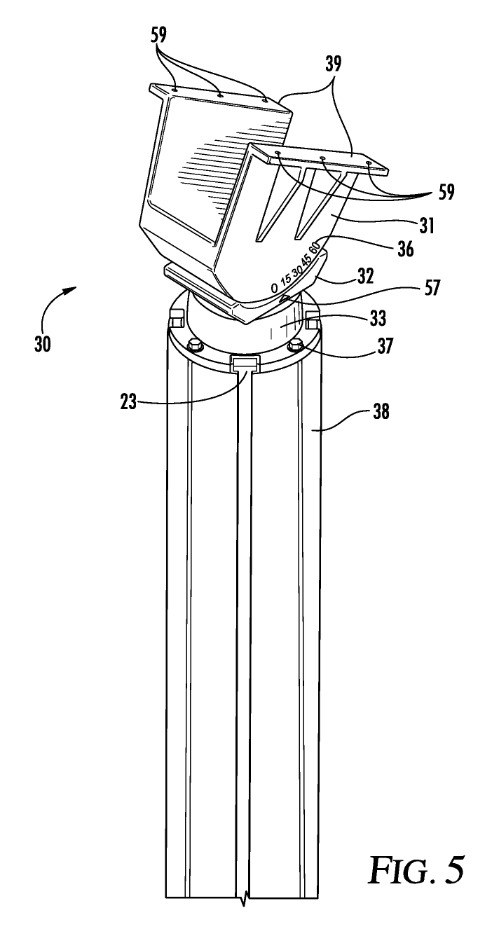

FIG. 5 depicts an assembled perspective view of an example of the adjustable mounting mechanism 30 in which the universal pivot bracket 31 is tilted at an angle of 30 degrees as indicated by the tilt angle markings 36 and the tilt angle indicator 57. A universal pivot bracket 31, universal A-Z bracket 32, and the universal TPM 33 are present at the top of pole component 38. Pole top bolts 37 secure the universal TPM 33 to the pole component 38. The pole top bolts 37 project through the universal TPM 33 and threadingly engage semi-circular grooves of the pole component 38. The universal TPM 33 may be constructed to correspond with the rectangular protrusions 23 of the pole component 38. The materials used for the adjustable mounting mechanism 30 may be any structure suitable for attaching a pole top item to a pole.

As depicted in FIG. 1, the example of an adjustable mounting mechanism 30 on the pole component 38 may be used to mount a photovoltaic array 42. The exemplary adjustable mounting mechanism 30 allows adjustment at installation so that the photovoltaic array 42 can be installed facing the correct direction and mounted at the optimum angle for the geographic location. The photovoltaic array 42 should be installed to face in the direction of the equator. FIGS. 4A, 4B, and 4C depict a universal pivot bracket 31, universal A-Z bracket 32, and the universal TPM 33. When the fastener 34 is loosened or removed, the universal A-Z bracket 32 may be rotated in a circular manner to change the direction that the pole top item faces. The tilt angle of a pole top item may be changed by sliding the universal pivot bracket 31 in relation to the universal A-Z bracket 32. The installer may rotate and/or adjust the tilt angle of the pole top item, such as a photovoltaic array 42, prior to or after installation of the pole top item.

Any type of attachment mechanism may be used that allows for the direction and tilt angle of a pole top item to be changed. A benefit of the use of the adjustable mounting mechanism 30 is that it requires little or no drilling while the installer is at the top of the pole component 38.

Another benefit of an adjustable mounting mechanism 30 with a universal pivot bracket 31, universal A-Z bracket 32, and the universal TPM 33 is that the pole top is rotatably adjustable in 360 degrees. This allows a pole component 38 to be installed with components of the adjustable mounting mechanism 30 attached or not. Once attached, the adjustable mounting mechanism 30 may later be adjusted to the required direction before (or after) attaching the photovoltaic array 42 or other pole top item. The interaction of the universal pivot bracket 31, universal A-Z bracket 32, and the universal TPM 33 with a fastener provide a secure interlocking at the top of the pole component 38 to maintain the required direction and tilt angle of the pole top item.

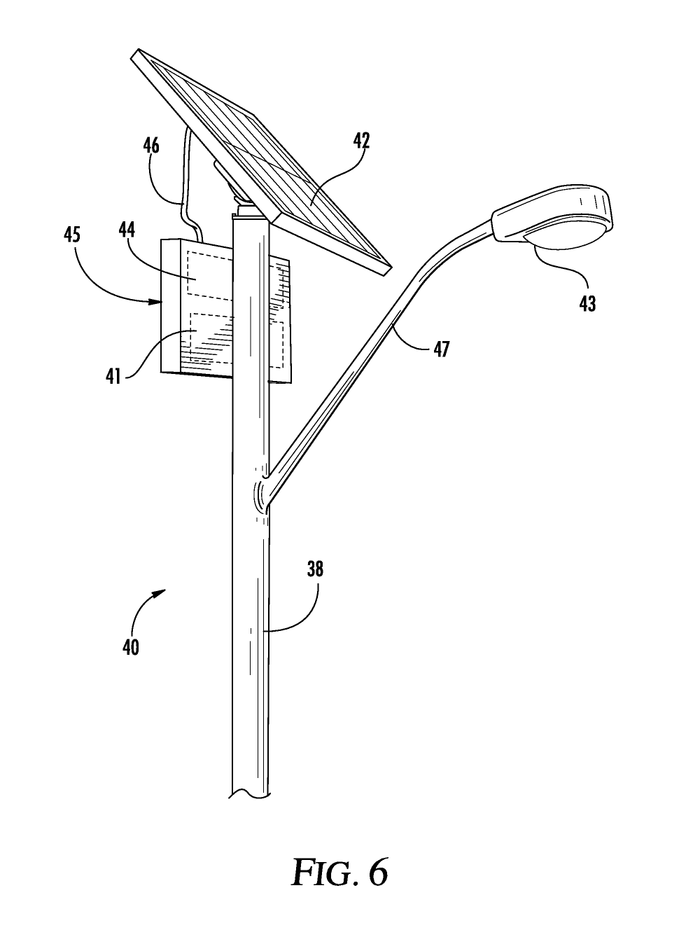

FIG. 6 shows an example of a solar lighting pole 40 indicating a possible location of the battery 41, battery box 45, and controller 44. FIG. 6 depicts a battery 41 and controller 44 located in a battery box 45. As shown in FIG. 6, the battery box 45 may be attached to the side of pole member 21 between the light fixture 43 and photovoltaic array 42 on the opposite side of the pole member 21 from the arm 47 and light fixture 43. As shown in FIG. 6, the light fixture 43 is attached to the side of the pole member 21 at the opposite end of arm 47 from pole member 21. Photovoltaic array 42 may be located at the top of pole component 38 and connected to the battery box 45 with wire 46. The battery 41 may be located at various other locations. For example, the battery 41 may be located under the photovoltaic array 42, at any location of the pole member 21, at the base of the pole member 21, underground, or any other suitable locations.

As discussed earlier, FIG. 1 depicts an example of a system for a solar street lamp 50 that comprises a light supporting system 20 and an adjustable mounting mechanism 30 used in combination. The system for a solar street lamp 50 comprises a base 12, tubular member 11, pole member 21, and an adjustable mounting mechanism 30 used together. The pole member 21 may be hollow or partially hollow, depending upon the needs of the project. The base 12 and tubular member 11 interact with a hollow or partially hollow pole member 21. Also depicted are a photovoltaic array 42, a light fixture 43, controller 44, battery box 45, and battery 41. The photovoltaic array 42 and battery box 45, as well as the lighting fixture 43, are interconnected with wires 46. The lighting fixture 43 may be attached to the pole member 21 or other structure on the system for a solar street lamp 50 that would allow the lighting fixture to provide adequate light. The top of the pole may be adjustable in one or more locations. The pole member 21 may be adjustable to allow rotational adjustment of the location of the light fixture. In an embodiment, the battery box 45 is located remotely.

A light supporting system 20 may be used with any pole top. The use of a light supporting system 20 is not dependent upon attachment of particular structures at the top of the pole. A light supporting system 20 may be used on a pole to support lights, antennas, cameras, or other pole top items. The example of a light supporting system 20 disclosed herein provides a time- and cost-effective structure for mounting a pole member 21.

The adjustable mounting mechanism 30 may be used with any type of pole and pole support structure. The use of the adjustable mounting mechanism 30 is not dependent upon the structure of the base of the pole or manner of attachment of the pole to a surface or foundation. In an embodiment, the adjustable mounting mechanism 30 may be used on a pole that has been buried underground or attached directly to a foundation with bolts. The adjustable mounting mechanism 30 disclosed provides a time- and cost-effective manner to attach structures to the top of a pole, particularly those structures for which the direction and angle that the structure faces is important.

A benefit of using the light supporting system 20 and adjustable mounting mechanism 30 in combination is that the example of a system for a solar street lamp 50 has both a secure interaction between the pole base 10 and pole member 21 and a secure structure at the top of the pole member 21 to maintain the required direction and tilt angle of the pole top item. These systems provide for ease of installation by allowing a pole base 10 to be installed at the desired location and the pole member 21 to be later placed upon the tubular member 11 of the pole base 10. At the time of installation of the adjustable mounting mechanism 30, which may be at the time of the pole member 21 installation or later, the facing direction and tilt angle of a pole top item may be adjusted. The facing direction and tilt angle of the pole top item may be adjusted at any time.

Variations and modification to the disclosure herein will be apparent to those skilled in the art. It is intended that such variations and modifications may be made without departing from the scope of the disclosure and without diminishing its attendant advantages.

All of the combinations and methods disclosed and claimed herein can be made and executed without undue experimentation in light of the present disclosure. While the combinations and methods of this disclosure have been described in terms of embodiments, it will be apparent to those of skill in the art that variations may be applied to the structural combinations and in the steps or in the sequence of steps of the methods described herein without departing from the concept, spirit, and scope of the invention. All such similar substitutes and modifications apparent to those skilled in the art are deemed to be within the spirit, scope, and concept of the disclosure as defined by the appended claims.

1. A pole support system comprising:
a base for securing the system to a ground surface;
a tubular member having a first end and a second end and with the second end being adapted for coupling to the base, wherein the tubular member has an exterior structure surface arranged in a repeating pattern of grooves and extending from the base;
a pole member having an interior structure arranged in a repeating pattern of protrusions corresponding to and adapted for matingly engaging with the grooves of the exterior structure of the tubular member;
the exterior structure and interior structure configured so that the pole member and the tubular member have a plurality of engaged positions,
wherein the pole member extends vertically to present an overhead top mounting surface.

2. The pole support system of claim 1, wherein the exterior structure comprises at least four grooves.

3. The pole support system of claim 1, wherein the grooves comprise grooves of a first width and grooves of a second width.

4. The pole support system of claim 1, wherein the grooves are substantially evenly spaced apart circumferentially at a predetermined angle from one another.

5. The circumferentially system of claim 4, wherein the grooves are spaced apart by an angle of about ninety degrees or less.

6. The pole support system of claim 3, wherein the grooves of a first width are semi-circular.

7. The pole support system of claim 6, wherein the grooves have a first end and a second end.

8. The pole support system of claim 7, wherein the grooves of a first width are tapered from the first end to the second end.

9. The pole support system of claim 1, wherein the width of the groove is less than spacing between the grooves.

10. The pole support system of claim 1, wherein the repeating pattern of grooves comprises two sets of grooves with a first set forming rectangle grooves and a second set forming semi-circular grooves.

11. The pole support system of claim 10, wherein the first set and second set of grooves are in an alternating pattern of rectangle grooves and semi-circular grooves.

12. The pole support system of claim 1, wherein the pole member in a first position is at a predetermined angle of rotation, with respect to the tubular member, from a second position.

13. A solar lamp system comprising:
a base for securing to a ground surface and supporting a vertically mounted pole member;
a tubular member having a first end and second end with the second end adapted for coupling to the base, wherein the tubular member has an exterior surface arranged in a repeating pattern of grooves;
a pole member having a first end and a second end;
wherein the first end of the pole member has an interior structure arranged in a pattern of protrusions corresponding to and adapted for matingly engaging with the grooves of the exterior structure of the tubular member;
the exterior structure and interior structure configured so that the first end of the pole member and the tubular member have a plurality of engaged positions;
a pole mount coupled to the pole member;
an arcuate bracket seated on the pole mount;
a pivot bracket conically engaged with the arcuate bracket; and
a fastener that projects through the pivot bracket, the arcuate bracket, and the pole mount and engages with the pole member.

14. The system for a solar street lamp of claim 13, further comprising at least one photovoltaic array attached to the pivot bracket.

15. The system for a solar street lamp of claim 13, wherein a pole top item attachment surface 39 of the pivot bracket is attached to a pivot bracket attachment surface of the photovoltaic array.

16. The system for a solar street lamp of claim 13, further comprising tilt angle markings and a tilt angle indicator.

17. The system for a solar street lamp of claim 13, further comprising a light fixture attached between the first end of the pole member and the second end of the pole member.

18. The system for a solar street lamp of claim 13, further comprising a battery box attached between the first end of the pole member and the second end of the pole member.

19. The system for a solar street lamp of claim 18, wherein the battery box has a battery and a controller disposed therein.
